(19) United States
(12) Patent Application Publication
(10) Pub. No.: US 2008/0176191 A1
(43) Pub. Date: Jul. 24, 2008

(54) ENDODONTIC ROTARY INSTRUMENTS FOR PREPARING ROOT CANAL SPACES

(75) Inventors: Kenneth Koch, Old Field, NY (US); Dennis Brave, West Palm Beach, FL (US)

Correspondence Address: FITZPATRICK CELLA HARPER & SCINTO, 30 ROCKEFELLER PLAZA, NEW YORK, NY, 10112, US

(73) Assignee: ENDODONTIC EDUCATIONAL SEMINARS, LLC, West Palm Beach, FL (US)

(21) Appl. No.: 12/016,323

(22) Filed: Jan. 18, 2008

Related U.S. Application Data
(60) Provisional application No. 60/886,015, filed on Jan. 22, 2007.

(51) Int. Cl. A61C 5/02; A61C 3/02

(52) U.S. Cl. 433/224; 433/144

(57) ABSTRACT

An endodontic cutting instrument for preparing root canal spaces of non-lengths standard length has a cutting portion that is equal to or greater than about 17 mm in length. The instrument is shaped to produce a conical root canal space with a uniform taper along the entire length of the conical root canal space, from an apex to a coronal opening thereof. The instrument may be part of an endodontic kit that includes multiple cutting instruments with respective cutting portions of different lengths and/or with respective cutting portions shaped to produce conical root canal spaces with different tapers. Optionally, the cutting instrument is provided with indicia for identifying its taper, the length of its cutting portion, or both. The indicia enables a user to quickly identify a suitable cone device for filling a root canal space prepared with the instrument.

### CROSS-REFERENCE TO RELATED APPLICATIONS

The present application claims benefit of U.S. Provisional Patent Application No. 60/886,015, filed on Jan. 22, 2007, the entire disclosure of which is incorporated by reference herein.

### FIELD OF THE INVENTION

This invention relates to an instrument for preparing dental radicular canals, or root canals, in which the length of the cutting or active working portion of the instrument is greater than the historical standard of 16 mm.

### BACKGROUND

Endodontics is the science of removing diseased and inflamed tissue from the inside of dental radicular canals, or root canals, and the region coronal to these canals, which commonly is referred to as the pulp chamber. During mechanical debridement, or removal of diseased and inflamed tissue, the root canal space is chemically debrided and disinfected through the use of irrigation agents. After completing the mechanical and chemical debridement, the root canal space is filled according to one of the many obturation methods known in the art.

Obturation is the sealing of a root canal by introducing one or more materials into the root canal space to fill and seal the space. Obturation methods generally use gutta percha, a naturally occurring trans isomer of rubber. The gutta percha is compacted vertically and/or laterally, and used in conjunction with a luting agent or cementing medium to form a seal between the gutta percha and the dentinal walls of the tooth. Filling and sealing the root canal space is required to prevent the ingress of contaminants.

Silver points have been used to fill the root canal space. However, due to leakage problems associated with their shape and the physical properties of the material itself, this technique was abandoned. In another method, a cold lateral filling is achieved by forcible condensation of gutta percha points instead of silver points. With this technique, however, it is often difficult to achieve a three-dimensional seal of the root canal space.

Subsequently, a condensation filling process was utilized in which gutta percha was heated or plasticized after insertion into the root canal space. With this method, however, there is undesirable shrinkage of the points upon cooling.

The use of a filling device made of gutta percha on a carrier (e.g., plastic, stainless steel, or the like) in conjunction with a large amount of cement has been advocated, but the lack of synchronicity between the dentinal walls of the root canal space and the surface of the filling device, as well as the cement not sufficiently adapting and bonding well to the dentinal walls and the gutta percha, make this method less than optimal. As used herein, the term “synchronicity” refers to a high degree of matching or conformity between the shape of the filling device and the shape of the root canal space.

Finally, the procedure of filling the entire root canal space with a cement or paste (and not using gutta percha at all) has been proposed. However, this procedure presents difficulties in controlling both the handling (e.g., extrusion) and shrinkage of the cement or paste.

Recently, an obturation technique called Activ GP™ was introduced. Activ GP™ uses a filling device made of a combination of gutta percha and a glass ionomer to create a monobloc between the device and the dentinal walls of the root canal space (see U.S. Pat. No. 7,097,455). As used herein, the term “monobloc” refers to the uniform bond between the dentinal walls of the root canal space and the Activ GP™ device, through use of a luting agent. The monobloc establishes and maintains a hermetic seal, thereby preventing the ingress of bacteria into the root canal space, which may have a deleterious effect on the long-term prognosis of the root canal filling procedure (i.e., endodontic therapy).

As described in U.S. Pat. Nos. 7,021,936 and 7,097,455, both of which are incorporated by reference herein in their entirety, the Activ GP™ filling device may be an integral one-piece core and cone structure, or it may be a cone without an integral core. The device works in combination with a root canal preparation area (i.e., endodontic preparation) created to incorporate the root canal space and to accommodate the device. The preparation area typically is conical, with a constant or uniform taper, and is sized to readily receive the device therein and thus to achieve synchronicity.

Generally, but not always, a 0.04 or a 0.06 taper is created through the use of a hand or manual cutting instrument or through use of a rotary mechanical cutting instrument. For example, a cutting instrument for creating a 0.04 taper in a root canal preparation area has a cutting portion that produces a cut shape that increases in diameter by 0.04 mm for every millimeter along the length or shank of the cutting portion, starting from a tip or apex at a distal end thereof. The cut shape generally is conical and has smooth walls (i.e., is devoid of steps or other discontinuities along the conical walls). Likewise, a cutting instrument for creating a 0.06 taper has a cutting portion that produces a cut shape that uniformly increases in diameter by 0.06 mm for each millimeter in length thereof. As will be understood by persons skilled in the art of endodontic techniques, the working or cutting portion of a cutting instrument is the portion that produces the tapered, conical shape of the prepared root canal space. The instrument may be made of stainless steel, nickel titanium, or any other material of suitable hardness to cut and/or grind tooth material.

The actual taper of an Activ GP™ filling device (also referred to herein as a cone device) is verified with a laser and made to match the “taper” of a cutting instrument used to prepare the root canal space. Laser verification may be performed at three different locations along the cone device (e.g., 1 mm from the apex (“D1”), 3 mm from the apex (“D3”), and 16 mm from the apex (“D16”)) to ensure the accuracy and uniformity of its dimensions and to ensure that its dimensions are the same as those of other cone devices of the same size. As will be appreciated by persons skilled in the art, the “taper” of a cutting instrument refers to the taper produced by the cutting instrument. This matched fit of the laser-verified cone device (i.e., the integral one-piece core and cone structure or the cone without the integral core) to the root canal preparation area, which is formed using an appropriately sized cutting instrument, results in synchronicity and allows both general practitioners and specialists to produce consistent, predictable, and reproducible endodontic therapy results.

Although the Activ GP™ obturation technique can be used to achieve synchronicity through the use of a cutting instrument sized to create a root canal preparation area with a conical taper that snugly accommodates a cone device with the same taper, and to achieve a monobloc that seals the root canal preparation area from the ingress of harmful bacteria and other undesirable matter, a problem arises when obturation is to be performed on root canals that are longer than 16 mm.

When the root canal space to be prepared for obturation is longer than 16 mm, conventional cutting instruments are insufficient for properly preparing the root canal space to snugly accommodate a cone device and achieve synchronicity. The radicular length (i.e., the root length) of a tooth can vary from person to person and from tooth to tooth for the same person. In general, root lengths are less than around 15 mm and therefore the standard 16-mm length of the cutting portion of conventional cutting instruments is adequate for properly preparing a root canal space for obturation. However, when a root length is greater than 16 mm, conventional cutting instruments are not able to cut or machine the root canal space to a tapered specification along the entire length of the root canal space. This inability to properly taper the entire root canal space prevents synchronicity from being achieved. That is, the failure to properly prepare a long root canal space to be uniformly tapered along its entire length prevents a similarly tapered cone device from being effectively inserted in the prepared root canal space so that the dentinal walls of the prepared root canal space snugly accommodate the walls of the cone device, from the tip of the cone device through the entire root length.

### SUMMARY OF THE INVENTION

The present invention addresses the above-described problems and provides instruments and methods for preparing root canal spaces of various lengths, including non-standard lengths, for obturation.

According to an embodiment of the invention, an endodontic cutting instrument is provided. The instrument has a cutting portion that is equal to or greater than about 17 mm in length and is tapered to enable a conically shaped root canal space to be prepared therewith. The instrument is adapted to be held and rotated by, for example, a rotary drill.

According to another embodiment of the present invention, an endodontic kit is provided. The kit includes at least one cutting instrument having a cutting portion with a length of about 17 mm or greater and a specified taper, and at least one cone device having the same specified taper. The kit enables users (e.g., dental practitioners, endodontists) to easily choose the right cone device to fill a root canal space prepared using a cutting instrument from the kit.

According to another embodiment of the present invention, an endodontic cutting instrument is provided with indicia for identifying its taper, the length of its cutting portion, or both. The indicia enables a user to quickly identify a suitable cone device for filling a root canal space prepared with the instrument.

According to another embodiment of the invention, a method is provided for preparing a root canal space for obturation. The method includes preparing or machining the root canal space with an instrument having a tapered cutting portion of a length greater than or equal to about 17 mm. The instrument is sufficiently long to shape the entire length of the root canal space uniformly, from apex to orifice, to produce a desired conical taper.

### BRIEF DESCRIPTION OF THE DRAWINGS

FIG. 1 schematically shows a section view of a tooth.

FIG. 2 schematically shows a sectional view of a root canal space prepared by a conventional cutting instrument having a cutting portion that is shorter in length than the length of the root canal space.

FIGS. 3A and 3B are sectional views schematically showing the lack of synchronicity between the root canal space of FIG. 2 and a conical obturation device used to fill the root canal space.

FIG. 4 schematically depicts a longitudinal cross section of a root canal space having multiple tapers.

FIG. 5 schematically depicts a prepared root canal space having a single, uniform taper.

FIG. 6 shows an endodontic cutting instrument, according to an embodiment of the present invention.

FIG. 7 shows a cutting portion of an endodontic cutting instrument, according to an embodiment of the present invention.

### DETAILED DESCRIPTION OF THE INVENTION

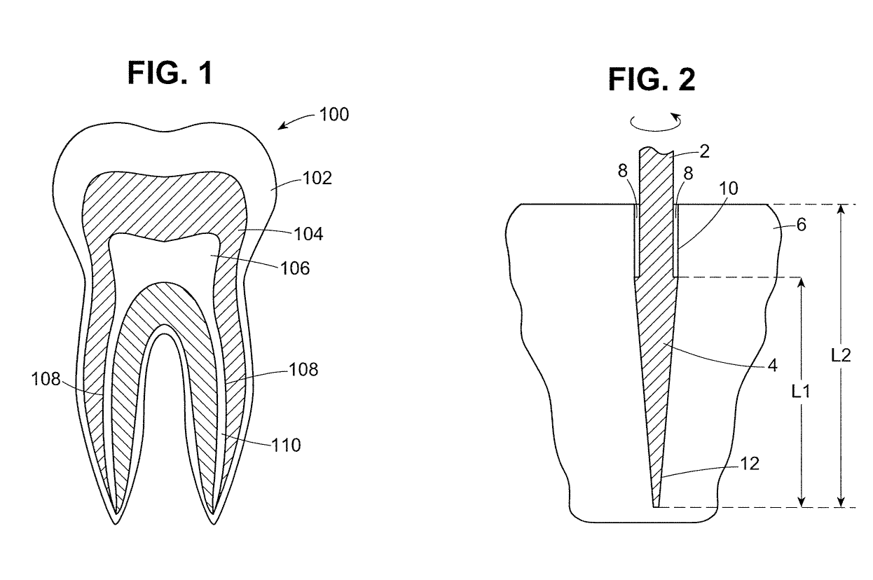

FIG. 1 schematically shows a sectional view of a tooth 100. The tooth 100 includes an enamel portion 102 surrounding an exterior surface thereof. A dentin portion 104 is located below the enamel portion 102 and surrounds a pulp portion 106. The pulp portion 106 is where the nerves and the blood vessels of the tooth 100 are located. The nerves (not shown) extend down the root portions 108 of the tooth 100, which are connected to the pulp portion 106.

During preparation of a root canal space 110 for obturation, diseased tissue is removed from the pulp portion 106 and the root portion 108 of the tooth 100. The prepared root canal space 110 must then be filled and sealed to prevent bacterial contamination. It is desirable to have a hermetic seal between the filling material and the dentinal walls surrounding the filling material to ensure that unwanted contaminants are excluded.

As schematically shown in the sectional view of FIG. 2, when a cutting instrument 2 used to machine a root canal space of a tooth 6 has a cutting portion 4 with a length L1 that is shorter than a length L2 of the root canal space, in order to machine down to the bottom or apex of the root canal space the cutting portion 4 of the cutting instrument 2 must extend into the tooth 6 beyond the length of the cutting portion 4 itself. This results in an upper portion 8 of the prepared root canal space 10 (having a length of L2-L1) being cylindrically shaped and a lower portion 12 being tapered or conically shaped. Consequently, synchronicity cannot be achieved between a cone device and the prepared root canal space 10. As will be appreciated by persons skilled in the art of dental instruments, although FIG. 2 shows the cutting instrument 2 to have a shank portion with a diameter less than the widest diameter of the cutting portion 4, so that the cylindrical upper portion 8 can readily be discerned from the figure, it is to be understood that the shank portion need not have a diameter less than the widest diameter of the cutting portion 4 but instead may have a diameter equal to the widest diameter of the cutting portion 4.

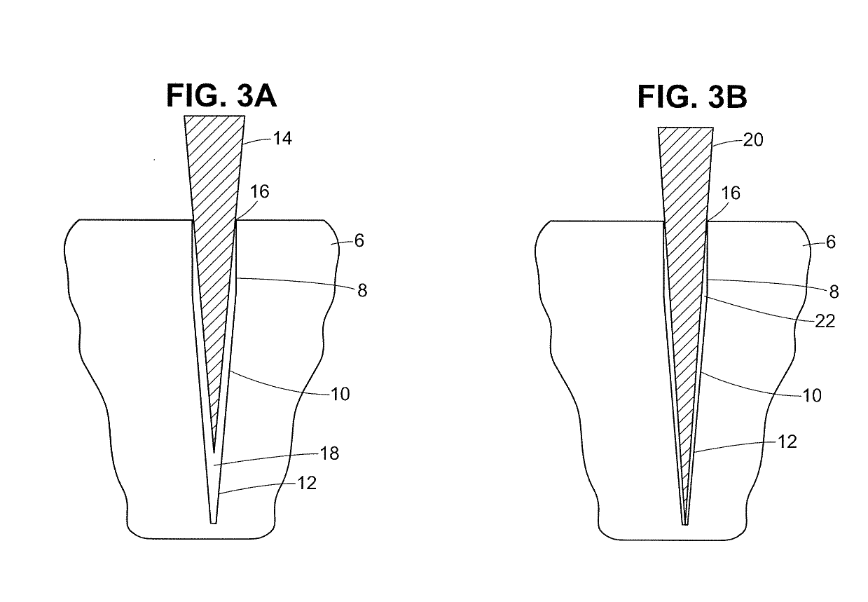

FIG. 3A schematically illustrates the lack of synchronicity between a cone device 14 having the same taper as the conically shaped lower portion 12 of the prepared root canal space 10. As evident from the figure, the cylindrically shaped upper portion 8 of the prepared root canal space 10 prevents the full insertion of a matching cone device 14 (i.e., a cone device having a matching taper) from extending down to the tip or apex of the prepared root canal space 10, and therefore synchronicity cannot be achieved. Because the cone device 14 has the same taper as the conically shaped lower portion 12 of the prepared root canal space 10, the portion of the cone device 14 having a diameter greater than the diameter of the orifice 16 of the prepared root canal space 10 prevents the cone device 14 from extending further into the prepared root canal space 10 and therefore a gap 18 is formed and synchronicity cannot be achieved.

FIG. 3B schematically illustrates the lack of synchronicity between a cone device 20 having a taper that is smaller than the taper of the conically shaped lower portion 12 of the prepared root canal space 10. As evident from the figure, the smaller taper of the cone device 20 enables the tip of the cone device 20 to reach and coincide with the tip of the prepared root canal space 10. However, the unmatched tapers of the cone device 20 and the conically shaped lower portion 12 of the prepared root canal space 10 causes a gap 22 to form and therefore prevents synchronicity from being achieved.

The conventional technique for coping with the problem of instrumenting (i.e., mechanically shaping) root canal spaces longer than 16 mm is to use cutting instruments having larger tapers (e.g., 0.08, 0.10, 0.12, etc.) with shorter cutting-portion lengths (e.g., 15 mm or less) to shape the coronal portion near the orifice of the canal. In preparing the coronal portion with a cutting instrument having a larger taper, a conical opening having a larger or wider diameter is produced, in comparison with openings formed by cutting instruments having smaller tapers (e.g., 0.06, 0.04, etc.). This wider-diameter conical opening enables cutting instruments of standard lengths and relatively smaller tapers to access the apical portion of the canal. However, although this conventional technique may be performed using standard cutting instruments to reach the apex of a canal that is longer than 16 mm, this technique sacrifices vital dentinal material in the coronal aspect or region of the canal, and forces dental practitioners to utilize costly and time-consuming techniques to fill this overly prepared coronal portion of the canal. With such excessive preparation, it is not possible to achieve synchronicity between a single cone device and the prepared (instrumented) root canal space, as discussed below.

Another concern with this conventional technique is that the use of cutting instruments with larger tapers to shape the coronal portion results in the weakening of the structural integrity of the tooth, because the larger tapers result in excessive removal of dentinal material from the coronal portion of the root. Consequently, the tooth is more prone to fractures, and the long-term prognosis for the tooth is diminished.

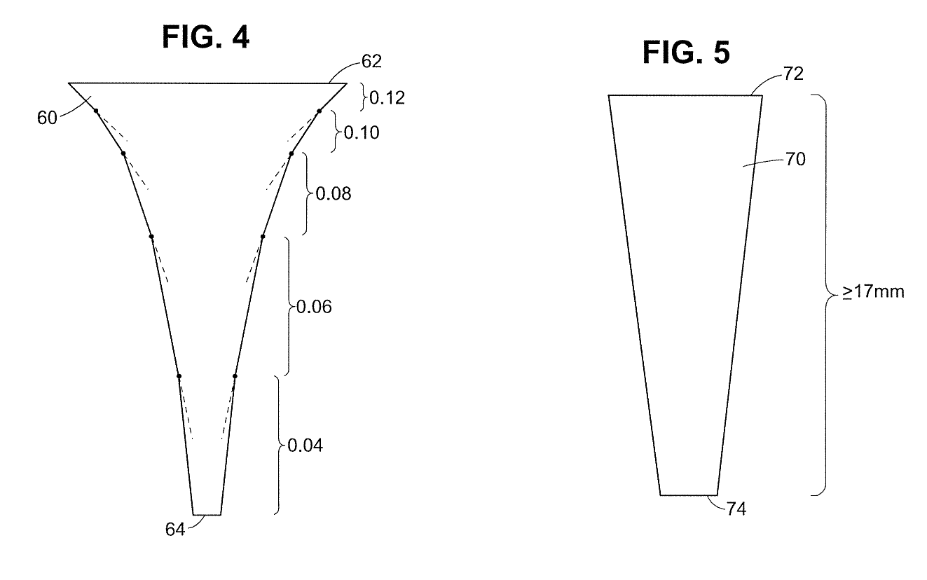

FIG. 4 schematically depicts a longitudinal cross section of a prepared root canal space 60 having multiple tapers that vary from 0.12 at the orifice 62 to 0.04 at the apex 64. The various tapers are formed using standard cutting instruments of progressively decreasing tapers to shape the root canal space 60. This variable-taper technique enables a root canal having a length greater than 16 mm to be prepared for obturation, because the space prepared by the first cutting instrument enables the second cutting instrument to access deeper into the root canal, which in turn enables the third cutting instrument to access even deeper into the root canal, and so on. However, as evident from the figure, the variable-tapered root canal space 60 cannot be obturated with a single cone device such that synchronicity is achieved from the orifice 62 to the apex 64.

The present invention addresses the above problems and provides instruments and procedures for preparing root canal spaces of various lengths, including non-standard lengths, such that the prepared spaces have a constant or uniform taper from apex to coronal opening. By extending the length of the cutting portion of a cutting instrument, such as a rotary file, to 17 mm or longer, dental practitioners can shape a root canal space to have a uniform and continuous taper that is smaller (0.06 or smaller) in canals that are greater than 16 mm in length, without sacrificing vital dentinal material. As a result, the root canal space can be obturated more expeditiously and synchronicity may be achieved. FIG. 5 schematically depicts a prepared root canal space 70 having a single, uniform taper from the orifice 72 to the apex 74. The root canal space 70 has a length that is 17 mm or greater. Preferably, the taper is no larger than 0.04 or 0.06 to minimize the unnecessary removal of vital dentinal material in a coronal portion near the orifice. As evident from the figure, the root canal space 70 may be obturated with a single cone device such that synchronicity is achieved from the orifice 72 to the apex 74.

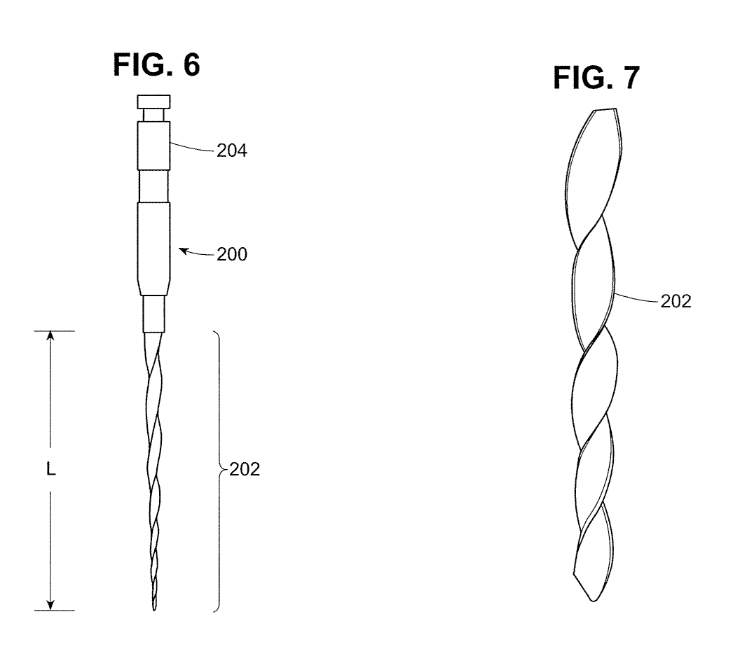

According to an embodiment of the invention, an endodontic cutting instrument 200 is provided, as shown in FIG. 6. The instrument 200 has a cutting portion 202, schematically shown in FIGS. 6 and 7, that is greater than 16 mm in length and is tapered (i.e., a cutting edge thereof is shaped to produce a specific taper) to enable a conically shaped root canal space to be prepared therewith. As will be appreciated by persons skilled in the art, the instrument 200 is adapted to be held by a rotary device such as a drill, for example.

In one aspect of the embodiment, the length L of the cutting portion 202 of the instrument 200 is greater than about 17 mm. Preferably, the length of the cutting portion is in the range of about 17 mm to about 22 mm.

In another aspect of the embodiment, the cutting portion 202 is shaped to produce a uniform taper in the range of about 0.03 mm to about 0.08 mm. As will be readily understood by persons skilled in the art, the value of a taper is the amount that a cone-shaped space bored or machined by the cutting portion 202 increases in diameter per mm in length, as measured from a distal tip of the instrument along a rotation axis of the cone-shaped space. Preferably, the taper is in the range of about 0.04 mm to about 0.06 mm.

In a further aspect of the embodiment, the cutting portion 202 is shaped to produce an apex or tip 74 (shown in FIG. 5) having a known diameter in the range of about 0.15 mm to about 11.10 mm. For example, the apex 74 formed by the cutting portion 202 has one of the following diameters (all in mm): 0.15, 0.20, 0.25, 0.30, 0.35, 0.40, 0.45, 0.50, 0.55, 0.60, 0.70, 0.80, 0.90 1.00, 1.10.

According to another embodiment of the invention, a set of endodontic cutting instruments is provided. At least one of the cutting instruments has a cutting portion with a length of about 17 mm or greater.

In one aspect of the embodiment, the instruments of the set have respective cutting portions with the same taper and with different lengths. For example, the cutting portions of the instruments may have a taper of 0.04 mm and may have lengths that respectively vary in increments of 1 mm, from 17 mm to 22 mm. This enables a user of the set to select an instrument with the optimal length for preparing a root canal space for a particular patient. Optionally, the lengths may vary in increments of 0.5 mm or another set value, or may vary in irregular increments.

In another aspect of the embodiment, the instruments of the set have respective cutting portions with the same length and with different tapers. For example, the cutting portions of the instruments may have a length of 18 mm and may have tapers that respectively vary in increments of 0.01 mm, from 0.03 mm to 0.08 mm or greater. This enables a user of the set to select an instrument with the best length for preparing a root canal space for a particular patient. Optionally, the tapers may vary in increments of 0.02 mm or another set value, or may vary in irregular increments.

In yet another aspect of the embodiment, the instruments of the set have respective cutting portions with different tapers and different lengths. For example, the cutting portions of the instruments may have lengths that respectively vary in increments of 1 mm, from 17 mm to 22 mm, and may have tapers that respectively vary in increments of 0.01 mm, from 0.03 mm to 0.08-mm or greater. This enables a user of the set to select an instrument with the optimal length and the optimal taper for preparing a root canal space for a particular patient. Optionally, the tapers may vary in increments of 0.02 mm or another set value, or may vary in irregular increments. Also, optionally, the lengths may vary in increments of 0.5 mm or another set value, or may vary in irregular increments.

In a further aspect of the embodiment, the instruments of the set have respective cutting portions with the same taper and different apex diameters (i.e., the apex diameters produced by the respective cutting portions are different).

In yet another aspect of the embodiment, the instruments of the set have respective cutting portions with different tapers and the same apex diameters.

According to another embodiment of the present invention, an endodontic kit is provided. The kit includes a cutting instrument having a cutting portion with a length of about 17 mm or greater and a specified taper, and at least one cone device having the same specified taper. With this embodiment, a user knows that, regardless of which instrument is used from the kit, a cone device selected from the kit will be appropriate for filling a root canal space prepared with the instrument.

In one aspect of the embodiment, the kit includes a set of cutting instruments and a set of cone devices. The cone devices all have the same taper. The cutting instruments have respective cutting portions with the same taper as the cone devices and with different lengths.

According to another embodiment of the present invention, an endodontic cutting instrument is provided with indicia for identifying its taper, the length of its cutting portion, or both. The indicia enables a user to quickly identify a suitable cone device for filling a root canal space prepared with the instrument.

In one aspect of the embodiment, the indicia is a color spot and a suitable cone device to be used with the instrument is marked with the same color as the color spot. For example, a handle portion 204 (shown in FIG. 6) of the instrument may have a red color spot and a suitable cone device is marked with the same red color.

In another aspect of the embodiment, the indicia is a symbol and a suitable cone device to be used with the instrument is marked with the same symbol. For example, the indicia may be one or more alphanumeric characters.

In yet another aspect of the embodiment, the instrument has a cutting portion with a length of about 17 mm or greater.

According to another embodiment of the present invention, an endodontic kit is provided. The kit includes a set of cutting instruments and a set of cone devices. At least one of the instruments of the kit has indicia for identifying its taper, the length of its cutting portion, or both. At least one of the cone devices of the kit has indicia matching the indicia of the instrument, to enable a user to quickly identify it as being suitable for filling a root canal space prepared with the instrument bearing the same indicia.

In one aspect of the embodiment, the indicia on the instrument is a color spot and the indicia on a suitable cone device is of the same color as the color spot.

In another aspect of the embodiment, the indicia on the instrument is a symbol and the indicia on a suitable cone device is the same symbol.

In yet another aspect of the embodiment, the kit includes at least one instrument having a cutting portion with a length of about 17 mm or greater.

In still another aspect of the embodiment, at least two of the instruments of the kit have respective cutting portions with different tapers, and at least two of the cone devices of the kit have corresponding different tapers. Matching indicia are used on instruments and cone devices with the same taper. Different indicia are used to identify different tapers. The indicia enables a user to easily choose the right cone device to fill a root canal space prepared using a particular instrument from the kit.

According to another embodiment of the invention, a method is provided for preparing a root canal space for obturation. The method includes boring the root canal space with an instrument having a cutting portion of a length greater than or equal to about 17 mm. The instrument is sufficiently long to shape the entire length of the root canal space to a desired conical taper.

In one embodiment of the invention, the conically shaped root canal space is filled with a cone device having the same conical taper, in order to achieve synchronicity. The cone device may be formed of a material that includes, for example, gutta percha. Preferably, the cone device is formed of gutta percha and a glass ionomer. Preferably, a luting agent is used to enhance bonding of the cone device to dentinal walls of the conically shaped root canal space, in order to achieve a monobloc structure.

In another embodiment of the invention, the instrument is marked with indicia for identifying a suitable cone device for filling the conically shaped root canal space. Preferably, the suitable cone device is marked with the same indicia. The indicia may be a color marking, a symbol marking, or any other type of visible marking.

By virtue of the various embodiments of the present invention, it is possible to prepare a uniformly tapered root canal space having a longer-than-standard length, such that the taper is constant from the apex of the space to the coronal opening of the space and such that the diameter of the apex may be selected to suit the desired shaping of the prepared space. In this way, the space may be obturated with a cone device having the same uniform taper and the same apex diameter in a synchronistic manner, and, with use of a luting agent or cement, a monobloc may be achieved between the cone device and the dentinal walls of the space.

The various embodiments of the present invention enables dental practitioners to avoid the use of multiple tapers in preparing root canal spaces for longer-than-standard teeth, thus increasing the long-term prognosis for those teeth. As discussed above, by avoiding the excessive removal of healthy tooth material, as typically would occur when there is excessively wide coronal shaping, the structural integrity of the teeth is not unduly compromised and the occurrence of tooth fractures diminishes.

The cutting instruments described in connection with the various embodiments of the present invention reproducibly and predictably produce constant tapers of precise dimensions while removing less of the coronal portion of the tooth than in conventional techniques. This preservation of healthy tooth material reduces the occurrence of tooth fractures in obturated teeth and thus increases the long-term prognosis for the teeth.

The above embodiments of the present invention have been described for purposes of illustrating how the invention may be made and used. It is to be understood that the present invention is not limited to the illustrative embodiments. Other variations and modifications of the invention and its various aspects will become apparent, after having read this disclosure, to those skilled in the art, and all such variations and modifications are considered to fall within the scope of the invention, which is defined by the appended claims.

What is claimed is:

1. An endodontic cutting instrument for preparing a root canal space for obturation, comprising:
a cutting portion having a length equal to or greater than about 17 mm; and
a handle portion marked with visible indicia,
wherein the cutting portion produces a uniform taper from an apex of a prepared root canal space to a coronal opening of the prepared root canal space.

2. An endodontic cutting instrument according to claim 1, wherein the cutting portion is shaped to produce a conically shaped root canal space having a specific taper.

3. An endodontic cutting instrument according to claim 2, wherein the specific taper is in the range of about 0.03 mm to about 0.08 mm.

4. An endodontic cutting instrument according to claim 1, wherein the visible indicia is a color marking.

5. An endodontic cutting instrument according to claim 1, wherein the visible indicia is a symbol.

6. An endodontic cutting instrument according to claim 2, wherein the visible indicia is used to identify a suitable cone device for filling the conically shaped root canal space.

7. An endodontic kit of cutting instruments for preparing a root canal space for obturation, comprising:
a plurality of cutting instruments each having a cutting portion,
wherein the respective cutting portions of the plurality of cutting instruments are shaped to produce a conically shaped root canal space having respectively different tapers, such that each cutting portion produces a uniform taper from an apex to a coronal opening of the conically shaped root canal space.

8. An endodontic kit of cutting instruments according to claim 7, wherein the different tapers vary from about 0.03 mm to about 0.08 mm.

9. An endodontic kit of cutting instruments according to claim 7, wherein the different tapers vary in regular size increments.

10. An endodontic kit of cutting instruments according to claim 7,
wherein the cutting portions of the plurality of cutting instruments have respectively different lengths, and
wherein at least one of the plurality of cutting instruments has a cutting portion having a length that is greater than of equal to about 17 mm.

11. An endodontic kit of cutting instruments according to claim 10, wherein the different lengths vary in regular size increments.

12. An endodontic kit of cutting instruments according to claim 7, wherein each of the plurality of cutting instruments has a handle portion marked with visible indicia used to identify a suitable cone device for filling a conically shaped root canal space formed with the cutting instrument.

13. An endodontic kit for preparing a root canal space for obturation, comprising:
a plurality of cutting instruments each having a cutting portion, wherein the respective cutting portions of the plurality of cutting instruments are shaped to produce a conically shaped root canal space having respectively different tapers; and
a plurality of cone devices each being suitable for filling a conically shaped root canal space formed using a cutting instrument from the plurality of the cutting instruments,
wherein each cutting portion produces a uniform taper from an apex to a coronal opening of the conically shaped root canal space.

14. An endodontic kit according to claim 13, wherein the different tapers vary from about 0.03 mm to about 0.08 mm.

15. An endodontic kit according to claim 13, wherein the plurality of cone devices include cone devices having respectively different tapers.

16. An endodontic kit according to claim 15, wherein the different tapers of the cone devices vary from about 0.03 mm to about 0.08 mm.

17. An endodontic kit according to claim 13,
wherein each of the plurality of cutting instruments is respectively marked with indicia,
wherein each of the plurality of cone devices is respectively marked with indicia, and
wherein indicia marked on a cutting instrument matches indicia marked on a cone device, the cone device is suitable for filling a conically shaped root canal space prepared by the cutting instrument.

18. A method for preparing a root canal space for obturation, comprising:
selecting a cutting instrument having a cutting portion greater than or equal to about 17 mm in length;
machining a root canal space with the selected cutting instrument, such that an entire length of the root canal space is shaped to a desired conical taper that is uniform from an apex to a coronal opening of the root canal space;
selecting a cone device for filling the shaped root canal space, wherein the cone device is formed of materials that include gutta percha and a glass ionomer;
coating one or both of the cone device and dentinal walls of the shaped root canal space with a luting agent to enhance bonding of the cone device to the dentinal walls; and
inserting the cone device into the shaped root canal space.

19. A method according to claim 18, wherein the cone device is an integral core and cone structure.

20. A method according to claim 18, wherein the cone device does not include an integral core portion.

21. A method according to claim 18, wherein the cone device is selected according to indicia on one or both the cone device and the cutting instrument.

22. A method for preparing a root canal space for obturation, comprising:
selecting a cutting instrument having a cutting portion greater than or equal to about 17 mm in length;
machining a root canal space with the selected cutting instrument, such that an entire length of the root canal space is shaped to a desired conical taper that is uniform from an apex to a coronal opening of the root canal space;
selecting a cone device for filling the shaped root canal space, wherein the cone device is formed of a material that includes gutta percha;
coating one or both of the cone device and dentinal walls of the shaped root canal space with a luting agent to enhance bonding of the cone device to the dentinal walls; and
inserting the cone device into the shaped root canal space.

23. A method according to claim 22, wherein the cone device is an integral core and cone structure.

24. A method according to claim 22, wherein the cone device does not include an integral core portion.

25. A method according to claim 22, wherein the cone device is selected according to indicia on one or both the cone device and the cutting instrument.
